(19) United States
(12) Patent Application Publication
(10) Pub. No.: US 2019/0091102 A1
(43) Pub. Date: Mar. 28, 2019

(54) TABLET PRINTING DEVICE AND TABLET PRINTING METHOD

(71) Applicant: Freund Corporation, Tokyo (JP)

(72) Inventors: Kiyoshi IMAI, Tokyo (JP); Eiichi HACHIYA, Tokyo (JP); Mutsuhito YONETA, Tokyo (JP)

(21) Appl. No.: 16/080,804

(22) PCT Filed: Feb. 27, 2017
(86) PCT No.: PCT/JP2017/007469

§ 371 Date: Aug. 29, 2018

(30) Foreign Application Priority Data
Mar. 5, 2016 (JP) 2016-042902

(51) Int. Cl. A61J 3/00; B41J 3/407; B41F 17/36

(52) U.S. Cl. CPC A61J 3/007; B41J 3/4073; A61J 2200/44; A61J 2200/70; A61J 2200/42; B41F 17/36

(57) ABSTRACT

A tablet printing device (1) has a conveying disk (C) that conveys a tablet (3) while sucking and supporting a side surface (5) of the tablet (3) and inkjet heads (4) and (6) capable of applying print processing to the side surface (5) and front and back surfaces (7a) and (7b) of the tablet (3) conveyed by the conveying disk (C). The tablet (3) is transferred from a conveying disk (A) to a conveying disk (B) at a tablet delivery part (8a) and transferred from the conveying disk (B) to the conveying disk (C) at a tablet delivery part (8b). The tablet (3) is sucked to and supported by a suction hole (28) formed in an end surface (Xc) of the conveying disk (C) with a large part of the side surface (5) and the entire front and back surfaces (7a) and (7b) thereof exposed. A tablet provider name or the like is printed on the side surface (5) of the tablet (3) by the inkjet head (4), and an active ingredient name and/or volume are/is printed on the front and back surfaces (7a) and (7b).

### TECHNICAL FIELD

The present invention relates to tablet printing technique for printing a product number, a product name, a trademark, or the like on the surface of a tablet and, more particularly, to a tablet printing device and method capable of applying print processing to the side surface of the tablet in a non-contact manner.

### BACKGROUND ART

Conventionally, a product number, a product name, a trademark or the like is written on the surface of a tablet or a capsule (hereinafter, referred to collectively as “tablet etc.”) for identification of a product and prevention of accidental ingestion. Such a display on the tablet is made by engraving at tabletting or print processing such as transfer printing or inkjet printing. In these methods, since the print processing by the inject printing is capable of applying printing to the tablet surface in a non-contact manner, it is thus less susceptible to powder adhering to irregularity of the tablet surface and excellent in sanitation. Thus, in recent years, various devices have been proposed as an inkjet type tablet printing device. For example, in Patent Document 1, a tablet printing device in which a tablet is conveyed by a conveyor belt with one surface (lower surface) of the tablet sucked and held, and predetermined print processing is applied to the other surface (upper surface) thereof by an inkjet head disposed on the conveying path is disclosed.

On the other hand, recently, in the pharmaceutical field, many generic drugs using off-patent ingredients are on the market. The generic drugs are lower in development and sales promotion costs while they have the same active ingredients as their original drugs. Thus, the generic drugs are provided at lower price than their original drugs, which is advantageous in medical expense reduction, and thus their use is increased. The generic drugs are supplied to the market with the same name and at the same price. In the case of a tablet, the active ingredients, volume, and the like are written on the surface of the tablet, and for these displays, inkjet printing technique is beginning to be utilized.

### CITATION LIST

### Patent Document

Patent Document 1: Japanese Patent No. 5,281,009

Patent Document 2: JP 2008-48924 A

Patent Document 3: JP 07-306516 A

### DISCLOSURE OF THE INVENTION

### Problems to be Solved by the Invention

However, the display of the active ingredients or volume is common among pharmaceutical companies, so that it is difficult to make differentiation from other companies' products. To cope with this, when the size of a tablet is increased, the printing surface is correspondingly increased, with the result that the name and logo of a tablet provider can be printed distinctly. However, an excessively large tablet is difficult to swallow, so that there is inevitably a limit to the size of the tablet. That is, when an easily swallowable tablet is pursued, the size (printable area) of the tablet is restricted, thus making it difficult to write many characters or marks on the tablet surface. When printing of many items is to be performed in this situation, even essential display item has to be made small and this impairs visibility of the tablet.

For a tablet, the quality of visibility may lead to erroneous dispensing by pharmacists or accidental ingestion of drug users such as patients and is thus a major problem for both parties and, thus, in the modern age in which elderly persons are increasing, improvement of the visibility of tablets is an urgent task. Further, it is also a problem for the tablet providers that it is difficult to let the drug users recognize the providers if the providers' names or logos cannot be written. Thus, there is required a tablet printing capable of contributing to an increase in awareness also in terms of business activity.

### Means for Solving the Problems

A tablet printing device according to the present invention includes: a conveying unit provided with a tablet holding part having a width smaller than the maximum diameter of a tablet and conveying the tablet while supporting the tablet on the tablet holding part; and a printing unit disposed in proximity to the conveying unit and capable of applying print processing to the side surface of the tablet conveyed by the conveying unit. In this case, the tablet holding part may suck and support the tablet.

Another tablet printing device according to the present invention includes: a conveying unit provided with a tablet holding part that sucks and supports a tablet and conveying the tablet while sucking and supporting the tablet on the tablet holding part such that at least half of the side surface of the tablet is exposed; and a printing unit disposed in proximity to the conveying unit and capable of applying print processing to the side surface of the tablet conveyed by the conveying unit.

In the present invention, the printing unit disposed in proximity to the conveying unit is used to apply desired print processing to the side surface of the tablet conveyed while being supported by the conveying unit. As a result, in addition to the front and back surfaces, printable range expands to the side surface, so that printable area is increased, and correspondingly, the size of a character to be printed can be made larger, or the number of characters to be printed can be increased, whereby visibility is enhanced. Further, the amount of information that can be displayed on the tablet is increased, and thus a product name, a mark, a pattern, a barcode or the like can be printed on the side surface of the tablet, thus making it possible to raise awareness of the tablet provider.

In the tablet printing device, a conveying disk formed into a disk shape may be used as the conveying unit, an end surface of the conveying disk may be used as the tablet holding part, and suction parts each sucking the tablet may be formed in the end surface so as to be arranged in the peripheral direction of the conveying disk. Further, the conveying unit may convey the tablet while sucking and supporting the side surface of the tablet. In addition, the tablet printing device may have, as the printing unit, a printing unit capable of applying print processing to at least front and back surfaces of the tablet conveyed by the conveying unit.

A tablet printing method according to the present invention may include: conveying a tablet while supporting the tablet by a conveying unit provided with a tablet holding part having a width smaller than the maximum diameter of the tablet; and applying print processing to the side surface of the tablet conveyed by the conveying unit by using a printing unit disposed in proximity to the conveying unit. In this case, the tablet holding unit may suck and support the tablet.

Another tablet printing method according to the present invention may include: conveying, by a conveying unit provided with a tablet holding part that sucks and supports a tablet, the tablet while sucking and supporting the tablet such that at least half of the side surface of the tablet is exposed; and applying print processing to the side surface of the tablet conveyed by the conveying unit by using a printing unit disposed in proximity to the conveying unit.

In the tablet printing method, the conveying unit may be used to convey the tablet while sucking and supporting the side surface of the tablet.

In the present invention, the printing unit disposed in proximity to the conveying unit is used to apply desired print processing to the side surface of the tablet conveyed while being supported by the conveying unit. As a result, in addition to the front and back surfaces, printable range expands to the side surface, so that printable area is increased, and correspondingly, the size of a character to be printed can be made larger, or the number of characters to be printed can be increased, whereby visibility is enhanced. Further, the amount of information that can be displayed on the tablet is increased, and thus a product name, a mark, a pattern, a barcode or the like can be printed, thus making it possible to raise awareness of the tablet provider.

### Advantages of the Invention

According to the tablet printing device and method of the present invention, the printing unit disposed in proximity to the conveying unit is used to apply desired print processing to the side surface of the tablet conveyed while being supported by the conveying unit. Thus, in addition to the front and back surfaces, printable range expands to the side surface, so that printable area is increased. As a result, the size of a character to be printed can be made larger, or the number of characters to be printed can be increased, whereby visibility is enhanced. Further, the amount of information that can be displayed on the tablet is increased, and thus a product name, a mark, a pattern, a barcode or the like can be printed, thus making it possible to raise awareness of the tablet provider. Furthermore, it is possible to contribute to prevent the erroneous handling of the tablet.

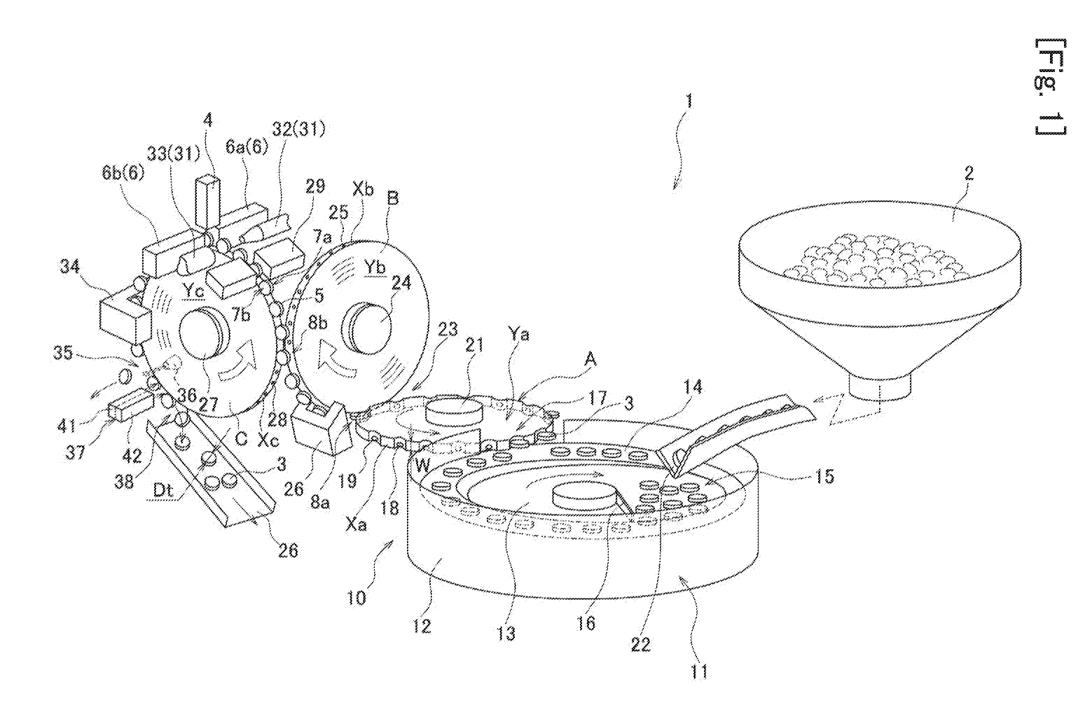

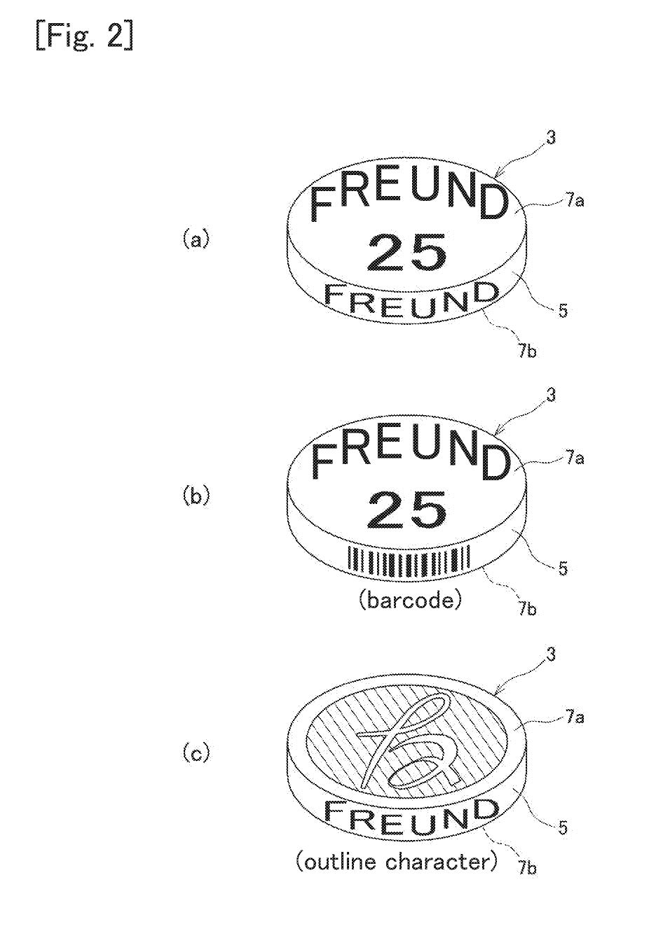

### BRIEF DESCRIPTION OF THE DRAWINGS

[FIG. 1] An explanatory view illustrating the entire configuration of a tablet printing device according to an embodiment of the present invention.

[FIG. 2] Explanatory views each illustrating an example of a tablet that has been subjected to print processing.

### BEST MODE FOR CARRYING OUT THE INVENTION

The object of the following embodiment is to provide a tablet printing device and method capable of enhancing visibility of printed characters or the like on the tablet surface and raising awareness of the tablet provider. FIG. 1 is an explanatory view illustrating the entire configuration of a tablet printing device 1 according to an embodiment of the present invention. The tablet printing device 1 of FIG. 1 sucks and conveys tablets 3 fed from a hopper 2 one by one with three conveying disks A, B, and C. Then, an inkjet head 4 is used to apply print processing to the side surface (belt part) 5 of the tablet 3 and an inkjet head 6 is used to apply print processing to front and back surfaces 7a and 7b of the tablet 3. The print processing on the side surface 5, front surface 7a, or back surface 7b may be omitted as needed.

In the tablet printing device 1, the tablets 3 are transferred from the conveying disk A (tablet supply disk) to the conveying disk B (first conveying disk) at a tablet delivery part 8a. Further, at a tablet delivery part 8b, the tablets 3 are transferred from the conveying disk B to the conveying disk C (second conveying disk). In the conveying disks A and C, the side surface 5 of each tablet 3 is sucked to and supported on end surfaces (tablet holding parts) Xa and Xc of the respective disks. In the conveying disk B, the front surface 7a or back surface 7b of each tablet 3 is sucked to and supported on an end surface (tablet holding part) Xb of the disk. The tablet 3 is conveyed to the inkjet heads 4 and 6 in a standing state (standing posture) where the side surface 5 is directed in the vertical direction. In the tablet printing device 1, the side surface 5 of the tablet 3 is subjected to printing by the inkjet head 4, and the front and back surfaces 7a and 7b of the tablet 3 are subjected to printing at the same time by the inkjet head 6. Then, only good products are discharged outside the device through a good product discharge part 38.

As illustrated in FIG. 1, the tablet printing device 1 is provided with the hopper 2, a rotary feeder (tablet feeder) 11, and the conveying disk A as a tablet supply unit 10. The hopper 2 stores the tablets 3 and feeds them to the rotary feeder 11. The rotary feeder 11 feeds the tablets 3 received from the hopper 2 to the conveying disk A. The conveying disk A sucks and conveys the tablets 3 from the rotary feeder 11 to the tablet delivery part 8a. The rotary feeder 11 is a so-called vibrationless rotary parts feeder and has a configuration in which a rotary disk 13 and an annular rotary plate 14 are coaxially provided in a cylindrical casing 12. The annular rotary plate 14 is disposed immediately inside the casing 12. The rotary disk 13 is disposed inside the annular rotary plate 14 in an inclined state. Apart of the outer periphery of the rotary disk 13 has the same height as the annular rotary plate 14 and the part serves as a communication part 15 between the rotary disk 13 and the annular rotary plate 14. The communication part 15 is provided with a guide plate 16 for guiding the tablets on the rotary disk 13 toward the annular rotary plate 14 side.

The casing 12 is partially cut out. The conveying disk A is disposed in such a manner that the outer peripheral portion thereof faces the cut out portion of the casing 12 to form a tablet acquisition part 17. The end surface Xa of the conveying disk A has a width W smaller than a maximum diameter Dt of the tablet 3. The end surface Xa has a plurality of circular suction holes (suction parts) 18 which are arranged at equal intervals in the peripheral direction. The suction holes 18 are connected to a suction device (not illustrated) such as a vacuum pump. A recessed part 19 in which the tablet 3 is introduced is formed around each of the suction holes 18 formed in the end surface Xa. The conveying disk A is disposed with a disk surface Ya thereof being substantially horizontal and is rotated about a vertically extending rotary shaft 21 in a direction denoted by the arrow by a drive source (not illustrated). As illustrated in FIG. 1, the conveying disks B and C provided at stages subsequent to the conveying disk A are disposed with disk surfaces Yb and Yc thereof being upright. On the other hand, the conveying disk A is disposed with the disk surface Ya being horizontal like a turn table. At the tablet acquisition part 17, the tablet 3 is sucked at its side surface 5 to the suction hole 18 of the conveying disk A and then conveyed to the conveying disk B in a horizontal posture (in a state where the front and back surfaces 7a and 7b face upward and downward in the vertical direction).

In the rotary feeder 11, the tablet 3 supplied from the hopper 2 is fed from a tablet supplying part 22 onto the rotating rotary disk 13. The tablet 3 on the rotary disk 13 moves in the peripheral direction with rotation of the rotary disk 13 and is then guided by the guide plate 16 to the annular rotary plate 14 being rotated at the same speed as the rotary disk 13. The tablet 3 on the annular rotary plate 14 moves in the peripheral direction with rotation of the annular rotary plate 14 to be fed to the tablet acquisition part 17. The tablet 3 fed to the tablet acquisition part 17 faces the end surface Xa of the rotating conveying disk A. At this time, if the tablet 3 coincides in posture and timing with the suction hole 18, it is sucked to the suction hole 18 while being fitted in the recessed part 19. That is, the tablet 3 sucked in a proper posture is conveyed by the conveying disk A to a tablet feeding part 23 which is a contact point with the conveying disk B. On the other hand, if the tablet 3 does not coincide in posture and timing with the suction hole 18 and thus is not sucked to the suction hole 18, it stays on the rotating rotary disk 13. That is, any tablet that does not assume a suction posture returns to the rotary feeder 11 and is then automatically conveyed toward the tablet acquisition part 17 once again (automatic return/automatic retry).

In the tablet printing device 1, the tablet 3 is sucked and conveyed from the rotary feeder 11 to the tablet feeding part 23 using the conveying disk A. By this suction conveyance, the tablet 3 can be picked up and fed to the conveying disk B in a guideless configuration where a guide member matching a tablet size is not used. In recent years, drugs, such as generic drugs, having different size or shape while maintaining the same ingredient are widely accepted in the market. Further, there are many cases that tablets of various sizes having different prescriptions exist although they are the same drugs. However, in a configuration where the guide member matching the tablet size provided between the tablet feeder and the tablet feeding part 23 is used to align the tablets 3 and guide them to the tablet feeding part 23, the guide member needs to be replaced by a proper one every time the size of the tablet is changed. Thus, even in the case of tablets of the same ingredient like the generic drug, when the sizes thereof are different, component replacement is required. Further, every time the component is replaced, the operation of the device must be interrupted to perform replacement/cleaning work, taking much labor and increasing processing time.

In contrast to this, in the tablet printing device 1, the tablet 3 is fed to the tablet feeding part 23 not using the guide member, but by the conveying disk A. As a result, the tablet can be fed to the subsequent stage in a proper posture irrespective of the tablet size as long as the tablet can be sucked to the disk, thereby flexibly dealing with tablets of various sizes. Thus, tablets of the same ingredients having various sizes can be conveyed in a mixed state, thereby significantly improving the processing efficiency. Further, the tablet printing device 1 performs print processing while the conveying disks B and C arranged at subsequent stages perform suction conveyance, so that it is also possible to achieve desired printing irrespective of the tablet size. That is, using the conveying disk A allows achievement of effective print processing exerting the features of the device at the maximum. Further, the tablet printing device 1 is not provided with a conveying guide, so that exchange or cleaning thereof need not be performed, thereby reducing man-hours for device maintenance. Additionally, the arrangement pitch of the suction holes 18 is previously determined, so that it is possible to prevent a large number of tablets exceeding the processing capacity from being fed to the tablet feeding part 23, which in turn prevents problems of jamming of tablets.

The tablet 3 is conveyed to the tablet feeding part 23 with rotation of the conveying disk A while maintaining the horizontal posture. Then, at the tablet delivery part 8a, the tablet 3 is handed over from the conveying disk A to the conveying disk B. At the tablet feeding part 23, the end surface Xa of the conveying disk A is disposed so as to adjacently face the end surface Xb of the conveying disk B in an orthogonal state, and the tablet delivery part 8a is formed between the conveying disks A and B. The conveying disks A, B, and C are synchronously driven so that the conveying speed of the tablet 3 is made constant considering transfer of the tablet therebetween. The conveying disk B is rotated about a rotary shaft 24 in a direction denoted by the arrow by a drive source (e.g., an electric motor; not illustrated). The end surface Xb of the conveying disk B has a flat surface with no projection. The end surface Xb has a plurality of circular suction holes (suction parts) 25 which are arranged at equal intervals in the peripheral direction. Like the suction holes 18, the suction holes 25 are connected to a suction device (not illustrated) such as a vacuum pump. The tablet 3 fed to the tablet feeding part 23 is sucked to the end surface Xb of the conveying disk B by the suction hole 25. At this time, the tablet 3 is held to the end surface Xb with one of the front and back surfaces 7a and 7b sucked thereto.

A side surface inspection device 26 is disposed near the conveying disk B. The side surface inspection device 26 is used for inspecting a state (presence/absence of cracking and chipping) of the side surface 5 of the tablet 3 sucked to and supported by the conveying disk B (side surface inspection). In the tablet printing device 1, a camera is used as the inspection device for inspecting the outer appearance or a printed state of the tablet. An image photographed by the inspection device is sent to a controller (not illustrated), where determination of nondefective/defective is made. A light and a pair of prisms are provided in the photographing range of the camera used for the side surface inspection device 26. The pair of prisms are disposed so as to face the tablet side surface. The camera photographs the state of the tablet side surface illuminated by the light 180 degrees at a time by two prisms. The side surface inspection device 26 can not only inspect the outer appearance of the tablet 3, but also measure the thickness thereof, so it can also determine a dimensional error. A tablet 3 in which any abnormality is detected is recognized as a defective and discharged through a defective product discharge part 35 provided at a stage subsequent to the conveying disk C without being subjected to print processing.

The tablet 3 sucked to the end surface Xb of the conveying disk B is put into an upright posture (a state where the side surface 5 is directed in the vertical direction) from the horizontal posture with rotation of the conveying disk B, subjected to the inspection by the side surface inspection device 26, and fed to the tablet delivery part 8b. The conveying disk C is disposed at the tablet delivery part 8b. The conveying disk C is rotated about a rotary shaft 27 in a direction denoted by the arrow by a drive source (not illustrated). The conveying disks B and C are disposed such that the rotary shafts 24 and 27 thereof are orthogonal to each other and are synchronously driven so as to convey the tablets at the same speed. As in the conveying disk B, an end surface Xc of the conveying disk C also has a flat surface with no projection. A width W of the end surface Xc is also smaller than the maximum diameter Dt of the tablet 3. The end surface Xc of the conveying disk C also has circular suction holes (suction parts) 28 which are arranged at equal intervals in the peripheral direction. The end surfaces Xb and Xc of the respective conveying disks B and C are disposed so as to adjacently face each other at the tablet delivery part 8b in an orthogonal state.

The tablet 3 is sucked to the end surface Xb of the conveying disk B at the tablet delivery part 8a and conveyed to the tablet delivery part 8b with rotation of the conveying disk B. The tablet 3 conveyed to the tablet delivery part 8b is sucked to the end surface Xc of the conveying disk C there and is then handed over to the conveying disk C side. In this case, at the conveying disk B side, suction force is imparted to the suction holes 25 until they reach a position at which both the disks B and C are closest to each other at the tablet delivery part 8b. The tablet 3 is sucked to the suction hole 28 of the opposing conveying disk C from the suction hole 25 losing the suction force at the disk closest approach position, and the tablet 3 is transferred to the conveying disk C.

The tablet 3 is sucked to the conveying disk B at one of its front and back surfaces 7a and 7b, so that the side surface 5 of the tablet 3 faces the end surface Xc of the conveying disk C at the tablet delivery part 8b. Thus, at the conveying disk C side, the side surface 5 of the tablet 3 is sucked and, accordingly, the tablet 3 is held to the end surface Xc in a standing state. Clearances between the conveying disks A, B, and C at the tablet delivery parts 8a and 8b can be changed in dimension according to the size of the tablet 3 and is automatically adjusted by inputting the tablet size through a control panel.

A print surface inspection device 29 is disposed at a stage subsequent to the tablet delivery part 8b so as to be in proximity to the conveying disk C. The print surface inspection device 29 inspects states of the front and back surfaces 7a and 7b of the tablet 3 sucked to and supported by the conveying disk C (print surface inspection). In the case of a scored tablet 3, the position of the scoring line is also detected by the print surface inspection device 29. As in the case of the side surface inspection device 26, a tablet 3 for which defective outer appearance is detected is recognized as a defective and discharged through the defective product discharge part 35 without being subjected to print processing.

The inkjet heads 4 and 6 are provided at a stage subsequent to the print surface inspection device 29. In the tablet printing device 1, a powder removing device 31 is provided at a former stage of the inkjet heads 4 and 6. The powder removing device 31 blows compressed air to the tablet 3 from a nozzle 32 to remove powder adhering to the tablet surface immediately before printing. The powder blown off from the tablet surface is collected by a suction tube 33. Powder such as drug adheres to the surface of a tablet formed by a tabletting machine. If print processing is applied to the tablet surface without removing the powder, the print may be erased from the tablet surface together with the powder, or print blurring may occur due to bleeding. To cope with this problem, in the tablet printing device 1, the powder removing device 31 is disposed immediately before the inkjet heads 4 and 6. As a result, powder adhering to the surface of the tablet 3 is removed. In addition, print processing can be performed before generation of new powder. Thus, it is possible to prevent erasing or bleeding of the print due to the powder adhering to the tablet surface, allowing clear and high-quality print processing to be obtained.

After clearance of the surface by the powder removing device 31, the inkjet head 4 is used to apply predetermined print processing to the side surface 5 of the tablet 3. The inkjet head 6 is used to apply predetermined print processing to the front and back surfaces 7a and 7b of the tablet 3. At the time of print processing, the tablet 3 is supported with the side surface 5 sucked, and thus a large part of the side surface 5 and the entire front and back surfaces 7a and 7b are exposed. Thus, in the tablet printing device 1, print processing can be thoroughly applied to the large part of the side surface 5 and the entire front and back surfaces 7a and 7b. Particularly, in applying print processing to the front and back surfaces 7a and 7b, an area where printing cannot be applied is not generated in the peripheral edge of the tablet.

Further, by intensively arranging the inkjet heads 4 and 6 at one position, print processing can be applied to the front and back surfaces 7a and 7b and the side surface 5 at the same time. Furthermore, the direction of characters to be printed on the front surface 7a of the tablet 3 and the direction of characters to be printed on the back surface 7b thereof can be made to coincide with each other according to the direction of the scoring line detected by the print surface inspection device 29. While, in the inkjet head 6, an inkjet head 6a for front surface and an inkjet head 6b for back surface are disposed so as to face each other at the same position, they may be displaced from each other. Similarly, the inkjet heads 4 and 6 may be displaced from each other. Further, a plurality of heads may be provided to accommodate multicolor printing.

FIGS. 2A to 2C are explanatory views each illustrating an example of the tablet 3 that has been subjected to print processing. As illustrated in FIG. 2A, an active ingredient name, a volume (“25”=25 g), a tablet provider name (manufacturer name or sales company name, “FREUND” in this example. The active ingredient name can be written in the same manner) are printed on the tablet 3. In this case, the active ingredient name, tablet provider name, and volume are printed on the front and back surfaces 7a and 7b, and the tablet provider name is printed on the side surface 5. Conventionally, printing is applied only to the front and back surfaces of the tablet, so that all the above items need to be written on the front and back surfaces, with the result that the tablet provider name becomes vary small or needs to be written in the form of abbreviation like “ABC”. Further, since all the above items are written only on the front and back surfaces, characters representing the active ingredient or volume tends to become small and is thus low in visibility.

In contrast to this, in the tablet 3 printed by the printing device 1, the tablet provider name can be printed on the side surface 5 of the tablet 3, so that the active ingredient name and volume to be printed on the front and back surfaces 7a and 7b can be made large. That is, printable range is not limited to the front and back surfaces like a conventional manner, it is enlarged to the side surface, so that printable area is increased, and correspondingly, the active ingredient name or the like can be made larger, or the number of characters to be printed can be increased, whereby visibility is enhanced. Further, the amount of information to be written on the tablet is increased, and thus a product name, a mark, a pattern, a barcode (FIG. 2B) or the like can be printed on the side surface 5, thus making it possible to raise awareness of the tablet provider and improve convenience of product management. Furthermore, in the case of drugs other than generic drugs, the design as illustrated in FIG. 2C can be made, in which a company's logo is printed large on the front and back surfaces, and the company's name is printed also on the side surface, thus making it possible to raise awareness by the design ingenuity.

A print inspection device 34 is provided at a stage subsequent to the inkjet heads 4 and 6. The print inspection device 34 is provided for checking a result of printing performed by the inkjet heads 4 and 6. When a printing defect is detected by the print inspection device 34, the corresponding tablet is discharged through the defective product discharge part 35 provided at a stage subsequent to the print inspection device 34. The defective product discharge part 35 is provided with a jet nozzle 36 that blows compressed air. A tablet 3 determined to have a defect in outer appearance or printing is blown off from the conveying disk C by the air blown from the jet nozzle 36 to be removed.

A drying/cooling device 37 is provided at a stage subsequent to the defective product discharge part 35. When the tablet 3 is conveyed to the good product discharge part 38 while the print surface thereof is yet to be dried, the ink may adhere to a carrying-out path 39 or print blurring may occur. In order to cope with this problem, in the tablet printing device 1, the drying/cooling device 37 is provided at a stage preceding the good product discharge part 38 so as to dry the print surface and solidify the ink. The drying/cooling device 37 is provided with a heating nozzle 41 and a cooling nozzle 42. In the drying/cooling device 37, the solvent of the ink is vaporized by hot air from the heating nozzle 41, and then the ink is cooled by cooling air from the cooling nozzle 42 to the melting point or lower thereof for solidification. Then, the print is fixed to the tablet surface, and only tablets 3 determined to be non-defective are discharged through the good product discharge part 38. As a result, it is possible to prevent the tablets determined to be non-defective from being stained by ink adhering to the carrying-out path 39 and to prevent print blurring due to rubbing of the print surface when the tablets 3 is rolling down the carrying-out path 39, thereby improving product quality and yield.

As described above, in the tablet printing device 1 according to the present invention, print processing is performed while sucking and supporting the side surface 5 of the tablet 3, so that a large part of the side surface 5 and the entire front and back surfaces 7a and 7b of the tablet 3 are not covered with the guide or the like for supporting the tablet. This allows inspection or print processing to be performed in a state where the surface to be printed is exposed, and prevents an area where inspection or print processing cannot be applied from being generated at the peripheral portion on the front and back surfaces of the tablet. Further, both the front and back surfaces can be subjected to printing without involving reversal of the tablet 3, and the side surface 5 can also be subjected to printing at the same time, thereby eliminating the risk of ink transfer or print blurring associated with the reversal of the tablet. In addition, the both surfaces of the tablet 3 can be subjected to printing at the same time, so that the directions of characters printed on the front and back surfaces 7a and 7b can be made to coincide with each other.

Thus, according to the tablet printing device 1, desired print can be efficiently applied to the entire front and back surfaces, thereby achieving improvement in the degree of freedom of print design, and reduction in printing time and device size. Further, desired print processing can also be applied to the tablet side surface, so that a printable area can be increased, whereby display of the active ingredient or the like can be made large, allowing enhancement in visibility. Furthermore, the name, trademark, logo, or the like of a tablet provider can be written on the tablet side surface, allowing an increase in awareness of the tablet provider. This allows intuitive visual confirmation of a tablet type or a tablet provider name, thereby facilitating distinction from placebo.

Further, in the tablet printing device 1, the tablet 3 is conveyed to the position of the inkjet heads 4 and 6, not using a conveying tool such as a magazine, but in a state of being sucked to and supported by the conveying disk C. Thus, in the inkjet heads 4 and 6, the tablet 3 can pass just near the head nozzle, allowing the distance between the head and the tablet to be reduced as much as possible. In particular, assuming that printing is applied to the tablet side surface in the belt conveyance system, when the belt width is larger than the maximum diameter of the tablet, the head cannot be brought closer to the tablet than the width of the belt, so that the distance between the head and the tablet becomes long, making it difficult to increase printing accuracy. In contrast to this, in the tablet printing device 1, print processing is performed with the side surface 5 of the tablet 3 sucked, so that the head can be disposed right close to the tablet side surface. Thus, printing accuracy with respect to the front and back surfaces and, further, the side surface can be enhanced to thereby realize the tablet printing enhanced in quality.

Furthermore, in the inkjet head 4 and 6 of the tablet printing device 1, an ink ejection amount is adjusted according to the shape of the side surface 5 or the front and back surfaces 7a and 7b, so that even when the print surface is a curved surface, printing can be performed without distortion. For example, in the case of a tablet whose front and back surfaces are spherical, there occurs a difference between the distance between the center portion of the tablet and the head nozzle and the distance between the peripheral portion thereof and the head nozzle. Therefore, if the tablet is printed in the same way at the center and peripheral portions, distortion may occur at the peripheral portion. Further, in print processing on the side surface 5, a difference may occur in the distance between the head nozzle and the tablet side surface along the circumferential direction. Thus, in the tablet printing device 1, the ejection amount of the head nozzle is adjusted according to shape information of the tablet so as to achieve easy-to-see printing free from distortion. While the shape information of the tablet can be input from a control panel of the device, thickness or outer diameter data of the tablet 3 measured by the side surface inspection device 26 can also be exploited.

The present invention is not limited to the above-described embodiment and may be variously changed within the scope of the invention.

For example, although circular tablets are subjected to print processing in the above embodiment, the tablet printing device according to the present invention may be applied not only to the circular tablets, but also to various types of tablets such as oblong tablets, caplets, and polygon-shaped tablets. Further, print processing can be applied not only to the tablets, but also to capsules (hard, soft). Thus, the “tablet” in the present invention is a concept that includes not only so-called circular tablets, but also tablets or capsules of various shapes.

Further, the shape of the suction hole formed in the conveying disk of the above embodiment is not limited to a circular shape, but may be an elliptical or polygonal shape. Further, a curved suction groove having an inner peripheral surface matching the tablet outer shape may be formed together with the suction hole. In this case, as the shape of the suction groove, various shapes such as a V- or U-like shape or a quadrangular shape may be adopted. For example, a substantially V-shaped groove may be formed in the tablet feeding disk so as to correspond to odd-shaped tablets such as triangular tablets. The most common shape of the tablet is a disk shape, and thus the groove is desirably formed into a curved shape to which the tablets slightly different in size can be fitted.

A recessed part similar to that of the conveying disk A may be formed in the end surfaces Xb and Xc of the conveying disks B and C, and conversely, the end surface Xa of the conveying disk A may be formed into a flat surface like the conveying disks B and C.

Furthermore, although the printing for the side surface 5 is performed on the conveying disk C in the above embodiment, it may be performed on the conveying disk B. The end surface Xb of the conveying disk B has a width smaller than the maximum diameter Dt of the tablet 3, so that, on the conveying disk B, the entire side surface 5 of the tablet 3 is exposed without interference of the conveying disk B. Thus, by changing the position of the inkjet head 4, print processing can be applied to a desired position of the side surface 5. Similarly, in the case of the belt conveyance, by using a belt having a width smaller than the tablet maximum diameter Dt, the distance between the head and the tablet can be reduced, thereby enabling the side surface print processing. As the conveying unit, a case shaped (box-shaped) magazine type conveying unit can be used in addition to the disk shape conveying unit as described above.

Further, printing of characters, marks, or the like or coloring may be performed over the entire periphery of the side surface 5. In this case, the inkjet head 4 is disposed, e.g., between the side surface inspection device 26 and the tablet delivery part 8b. In a tablet printing device configured to perform only the side surface print processing, the conveying disk C may be omitted. In this case, the print inspection device 34, defective product discharge part 35, drying/cooling device 37, good product discharge part 38, and the like are disposed on the conveying disk B side.

### INDUSTRIAL APPLICABILITY

The present invention may be applied to printing for medical tablets, but also for food such as confectionery having a tablet shape.

### REFERENCE SIGNS LIST

1: Tablet printing device
2: Hopper
3: Tablet
4: Inkjet head (for side surface: printing unit)
5: Tablet side surface
6: Inkjet head (for front and back surfaces: printing unit)
6a: Inkjet head for front surface (printing unit)
6b: Inkjet head for back surface (printing unit)
7a: Tablet front surface
7b: Tablet back surface
8a: Tablet delivery part
8b: Tablet delivery part
10: Tablet supply unit
11: Rotation feeder
12: Casing
13: Rotary disk
14: Annular rotary plate
15: Communication part
16: Guide plate
17: Tablet acquisition part
18: Suction hole (suction part)
19: Recessed part
21: Rotary shaft
22: Tablet supplying part
23: Tablet feeding part
24: Rotary shaft
25: Suction hole (suction part)
26: Side surface inspection device
27: Rotary shaft
28: Suction hole (suction part)
29: Print surface inspection device
31: Powder removing device
32: Nozzle
33: Suction tube
34: Print inspection device
35: Defective product discharge part
36: Jet nozzle
37: Drying/cooling device
38: Good product discharge part
39: Carrying-out path
41: Heating nozzle
42: Cooling nozzle
A: Conveying disk (tablet supply disk)
B: Conveying disk (first conveying disk: conveying unit)
C: Conveying disk (second conveying disk: conveying unit)
Dt: Tablet maximum diameter
W: Disk end surface width
Xa: Disk end surface (tablet holding part)
Xb: Disk end surface (tablet holding part)
Xc: Disk end surface (tablet holding part)
Ya: Disk surface
Yb: Disk surface
Yc: Disk surface

1. A tablet printing device characterized by comprising:
a conveying unit that is provided with a tablet holding part having a width smaller than the maximum diameter of a tablet and conveys the tablet while supporting the tablet on the tablet holding part; and
a printing unit disposed in proximity to the conveying unit and capable of applying print processing to the side surface of the tablet conveyed by the conveying unit.

2. The tablet printing device according to claim 1, characterized in that
the tablet holding part sucks and supports the tablet.

3. A tablet printing device characterized by comprising:
a conveying unit that is provided with a tablet holding part that sucks and supports a tablet and conveying the tablet while sucking and supporting the tablet on the tablet holding part such that at least half of the side surface of the tablet is exposed; and
a printing unit disposed in proximity to the conveying unit and capable of applying print processing to the side surface of the tablet conveyed by the conveying unit.

4. The tablet printing device according to claim 2 or 3, characterized in that
the conveying unit is a conveying disk formed into a disk shape,
the tablet holding part is an end surface extending in the peripheral direction of the conveying disk, and
the conveying disk has suction parts formed in the end surface thereof so as to be arranged in the peripheral direction and each sucking the tablet.

5. The tablet printing device according to any one of claims 2 to 4, characterized in that
the conveying unit conveys the tablet while sucking and supporting the side surface of the tablet.

6. The tablet printing device according to any one of claims 1 to 5, further comprising, as the printing unit, a printing unit capable of applying print processing to at least front and back surfaces of the tablet conveyed by the conveying unit.

7. A tablet printing method characterized by comprising:
conveying a tablet while supporting the tablet by a conveying unit provided with a tablet holding part having a width smaller than the maximum diameter of the tablet; and
applying print processing to the side surface of the tablet conveyed by the conveying unit by using a printing unit disposed in proximity to the conveying unit.

8. The tablet printing method according to claim 7, characterized in that
the tablet holding unit sucks and supports the tablet.

9. A tablet printing method characterized by comprising:
conveying, by a conveying unit provided with a tablet holding part that sucks and supports a tablet, the tablet while sucking and supporting the tablet such that at least half of the side surface of the tablet is exposed; and
applying print processing to the side surface of the tablet conveyed by the conveying unit by using a printing unit disposed in proximity to the conveying unit.

10. The tablet printing method according to claim 8 or 9, characterized in that
the conveying unit conveys the tablet while sucking and supporting the side surface of the tablet.
